(19) United States
(12) Patent Application Publication
(10) Pub. No.: US 2005/0084265 A1
(43) Pub. Date: Apr. 21, 2005

(54) Method of allocating a resource in a multigranular telecommunications network

(75) Inventors: Emmanuel Dotaro, Verrieres Le Buisson (FR); Martin Vigoureux, Paris (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/951,787

(22) Filed: Sep. 29, 2004

(30) Foreign Application Priority Data
Sep. 30, 2003 (FR) 03 11 411

(51) Int. Cl. H04J 14/00

(52) U.S. Cl. 398/49

(57) ABSTRACT

The method aims to allocate a resource (WB1) in a telecommunications network (10) having a multigranular architecture and a given topology defining links, the network comprising first resources called higher resources having a higher granularity than second resources called lower resources. The method comprises a step No. 1 of determining traffic demands relating to said lower resources, a step No. 2 relating to subpaths with a cost function, a step No. 3 comprising electing the best subpath (BE) given the cost function and allocating at least one higher resource to said best subpath for handling at least a portion of the lower resources, a step No. 4 of updating the traffic demands relating to the lower resources, and a step No. 5 of reiterating steps No. 2 to No. 4 until any allocation of a higher resource provides no further improvement in the light of the cost function.

The present invention relates to the field of telecommunications and more precisely to a method of allocating a resource in a telecommunications network having a multigranular architecture.

As is known in the art, a hierarchical telecommunications network uses a set of resources with different granularities, for example the following resources, here classified in order of increasing granularity:
packets,
cells and frames (ATM, Frame Relay, Ethernet),
circuits associated with TDM circuit switching matrices,
wavelengths associated with wavelength switching matrices (optical cross-connect),
bands of wavelengths associated with band of wavelength switching matrices (waveband optical cross-connect),
optical fibers associated with space switches, and
optical fiber cables.

The above granularity order corresponds in fact to an encapsulation hierarchy that may be used in existing networks.

At present, rating a hierarchical network, i.e. choosing the number, capacities and distribution of the resources with different granularities, is generally based on combinatorial optimization methods (integer linear programming, heuristic or metaheuristic methods) using as input a traffic matrix, for example a static traffic matrix, representing traffic demands at a given time, and usually representing the traffic demand peak.

These global analytical methods minimize or maximize variables and, because of their complexity, entail many approximations.

The existing methods are very cumbersome to use, slow, and above all very limited. They are not designed to take account of real and increasingly strong constraints in terms of traffic fluctuations (traffic distribution varying in time and in space) and/or management of the various protocols to optimize routing.

The present invention aims to overcome these problems by providing an intelligent method of allocating resources for improved rating of the network under construction, in the same way as dynamic reconfiguration in response to a request.

To this end, the invention proposes a method that involves multigranular network elements, and it is necessary to understand these clearly first. For a given network topology, “links” may be defined for each level of granularity that consist of connections between adjacent nodes of the network for the level of granularity concerned. The topology may be the physical typology or a logical typology corresponding to a higher level of granularity. Thus a link may be a physical point-to-point link between two physically adjacent nodes or a logical link between a first node and a final node that are not physically adjacent.

A “route” in the network and for a given level of granularity is an itinerary from a departure node to an arrival node. A route therefore consists either of a single link or of a succession of consecutive links separated by nodes.

Within a route, subpaths may be defined each consisting of a section of the route delimited by any two nodes of the route, including the departure and arrival nodes delimiting the route. A subpath of a given route is therefore identified by the two nodes at its ends, called the entry node and the termination node.

A traffic demand is defined between a source node and a destination node and, if it leads to an effect, corresponds to a volume of traffic between these two nodes. A volume of traffic on a subpath is then the total volume of traffic conveyed end-to-end by that subpath, i.e. from its entry node to its termination node.

To be more precise, the invention proposes a method of allocating a resource in a telecommunications network having a multigranular architecture and a given topology defining, for each level of granularity, nodes and links between adjacent nodes, the network comprising a first resource called the higher resource having a higher level of granularity than second resources called lower resources, which method is characterized in that it comprises the following steps:
a step No. 1 of determining traffic demands between source nodes and destination nodes and relating to said lower resources,
a step No. 2 comprising:
   routing, i.e. distributing traffic demands over at least some of the links, the routing process defining routes,
   counting subpaths relating to said routes, a subpath being identified by an entry node and a termination node situated on one of said routes,
   determining the traffic volume on each of said subpaths as a function of said traffic demands, and
   applying a cost function on each of said subpaths, the cost function being used to evaluate an improvement,
a step No. 3 comprising:
   electing from said subpaths a best subpath for which the improvement evaluated by the cost function is a maximum, and
   allocating at least said higher resource to said best subpath for handling at least some of the lower resources and the corresponding traffic,
a step No. 4 of updating the traffic demands relating to the lower resources, comprising:
   eliminating the traffic demands at the origin of traffic initially intended to take this best subpath by means of said portion of the lower resources, but handled by said higher resource,
   introducing traffic demand(s) adjacent said best subpath in each situation where a traffic demand handled by said higher resource: 1/ has for its source node a node on the upstream side of said entry node and does not involve crossing said termination node, or 2/ has for its destination node a node situated on the downstream side of said termination node and does not involve crossing said entry node, or 3/ has for its source node and its destination node respective nodes upstream of said entry node and downstream of said termination node, the adjacent traffic demands introduced being respectively, in situation 1/, the traffic demand with said entry node for the new destination node, in situation 2/, the traffic demand with said termination node for the new source node, and in situation 3/, the traffic demand with said entry node for the new destination node and the traffic demand with said termination node for the new source node, and
a step No. 5 of reiterating steps No. 2 to No. 4 until any allocation of a higher resource provides no further improvement.

A first advantage of the above method is that it is easy to use because it is iterative and each iteration consists of relatively simple operations. Another important advantage is that it always converges toward a suitable configuration.

A knowledge of the traffic demands may be obtained using an intradomain routing protocol such as the IETF's Interior Gateway Protocol (IGP) or from local and/or global statistical traffic analyses.

Similarly, the triggering of allocation of resources in accordance with the invention may be linked to several types of event. One or more higher resources may be allocated temporarily or permanently.

For example, given the granularity levels, one consequence of the logical nature of the links is that, if a wavelength band connection is already set up or planned between two nodes that are not physically adjacent, on the first iteration of the method the routing performed in step No. 1 for wavelengths will consider this multilink connection between the two nodes as a single link.

Examples that may be cited include traffic engineering (TE) logical links (TE-links) used for routing in the Open Shortest Path First-Traffic Engineering (OSPF-TE) protocol of a Generalized Multi-Protocol Label Switching (GMPLS) network. The link is of the Forwarding Adjacencies (FA) type and comes from a Label Switched Path (LSP) of given granularity.

Step No.1 may preferably be based on using, at will:
a static traffic matrix, representing traffic demands at a given time not necessarily linked to the traffic peak,
preferably, a plurality of static traffic matrices representing traffic demands at separate times,
a stochastic traffic matrix representing the intensity of traffic demands at a given time, for example on the basis of Poisson's law, and
a plurality of stochastic traffic matrices representing the intensity of the traffic demands at different times.

In this way, the method may take the variable nature of the traffic into account by statistical estimation based on appropriate time samples and possibly using methods of approximating or predictively estimating the evolution of traffic, for example by establishing gradients.

The number of matrices is chosen and/or the sampling is chosen as a function of the scales of traffic variations in time and space.

In a first preferred embodiment, the routing process uses a Dijkstra routing algorithm and each subpath corresponds to a shorter path.

In a route calculation using the Dijkstra algorithm with a metric at 1 and corresponding to the number of hops, any subpath between two points of a shorter path is itself a shorter path. This simple routing process does not depend on time or context. Because not all the subpaths of the graph are taken into account, the number of items of data to store is small.

In a second preferred embodiment, given the cost function, the routing process predictively integrates a maximum improvement.

This intelligent routing process takes into account the way in which traffic is processed. Thus the expected maximum improvement will be increased by taking account of routing constraints.

According to one advantageous feature, the cost function may take into account one or more of the following parameters: the lengths of the subpaths, physical constraints, and administrative cost.

The physical constraints are linked to geographical characteristics, for example.

The physical constraints are also linked to the number of means to be provided. Thus the allocation of a higher resource such as a band of wavelengths must take account of the possible addition of optical regenerators to compensate optical attenuation and/or to correct nonlinear optical phenomena of a very long subpath. The need for such regenerators has to be set against the number of lower connections saved, for example with the advantages of minimizing the size and/or the number of IP routers.

The administrative cost is linked to a location of the network, for example.

Also, the cost function takes account of these parameters in addition to the volume of traffic.

When the lower resources are wavelengths and the higher resource is a wavelength band, the cost function uses the number of wavelengths to be included in the band.

If the lower resources are packets sent discontinuously, the cost function need not use the mean volume of the traffic, but rather an estimated value between the mean volume and the traffic peak.

Also, if said lower resources are packets, the cost function takes into account an estimate of the equivalent bandwidth. For example, the equivalent bandwidth is explained in the document “Equivalent Capacity and Its Application to Bandwidth Allocation in High-Speed Networks”, R. Guerin, IEE Journal on Selected Areas of Communication, Vol. 9, No. 7, September 1991.

According to an advantageous feature, step No. 4 may comprise the formation of a new link in the topology between the entry node and the termination node of the best subpath. This new link may be used as a link for routing at the time of a new allocation of a resource.

In a preferred embodiment, the step No. 4 may comprise the management of a memory associated with the higher resources allocated, said memory comprising one or more of the following: the number of hops for each best subpath, the length of each best subpath, the entry and termination nodes of each best subpath.

Step No. 1 may comprise determining the distribution of the traffic demands in time and in space by software or hardware means. This determination may be effected by means distributed in said network, and to be more precise by its control plane. The control plane delivers information from a routing protocol dedicated to the lower resources.

At the level of Internet Protocol (IP) routers, for example, the protocol information is given by the OSPF-TE protocol that floods the whole of the network with the state of the links, in particular with TE attributes declaring, among other things, the bandwidth used.

The determination may also be effected by external and centralized management means (off-line management).

Furthermore, the traffic demands may also be determined from information supplied by distributed measuring means in the network controlled either automatically or manually by a central operator.

If traffic demands are independent or are dependent to a degree that is tolerable given the cost function, steps No. 2 and No. 3 may lead, in the same iteration, to the election of at least two different best subpaths and to the allocation of at least two higher resources.

The lower resources may be selected from the group comprising packets, circuits, wavelengths, wavelength bands, and optical fibers, and the higher resource or resources may be selected from the group comprising circuits, wavelengths, wavelength bands, optical fibers, and optical fiber cables.

The higher resource and the lower resources may be adjacent or non-adjacent in terms of granularity levels.

The method of the invention may be used to rate or dynamically reconfigure a network or to rate two networks that are superposed in terms of encapsulation hierarchy.

Other features and advantages of the present invention will become apparent in the course of the following description of a preferred embodiment of the invention, which is given by way of non-limiting and illustrative example and with reference to the accompanying drawing, in which:

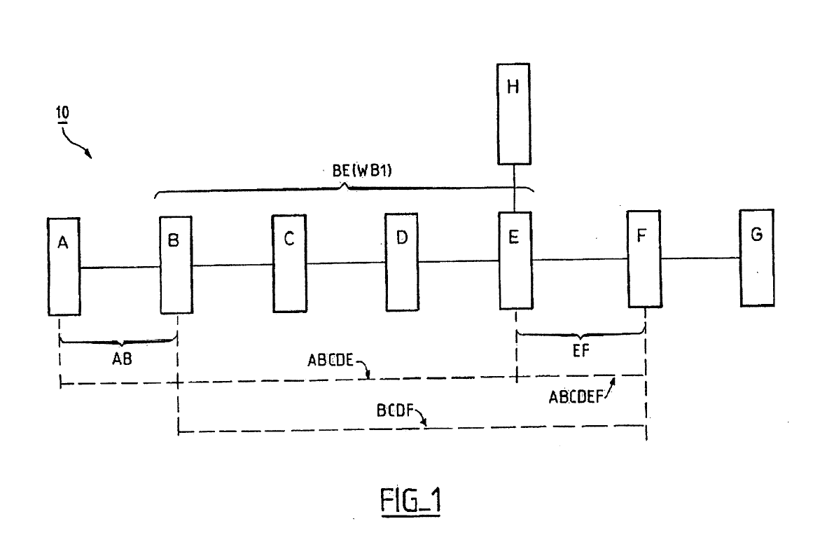

FIG. 1 is a diagram representing a telecommunications network for implementing a preferred embodiment of a method in accordance with the invention of allocating a resource.

FIG. 1 is a simplified representation of a telecommunications network 10 to be rated.

The network 10 has a topology comprising eight nodes A to H connected by physical point-to-point links that are non-directional, for example.

The network 10 has a multigranular architecture and may use a first resource called a higher resource, such as a wavelength band WB1, and second resources called lower resources, such as a plurality of wavelengths.

The wavelength band WB1 is of variable size and contains twenty usable wavelengths, for example.

Thus the network 10 is to be organized hierarchically into regions as defined in the GMPLS series of protocols from the IETF, a region corresponding to all the resources that switch the same granularity. The method of the invention of allocating resources is used to rate the network under construction.

In step No. 1 of this method, traffic demands between source nodes and destination nodes are determined first from a traffic matrix that is static in terms of the number of wavelengths.

The matrix indicates three traffic demands, for example:
the first traffic demand corresponds to transmission between A and F, for example corresponding to the use of three wavelengths (3λ) ,
the second traffic demand corresponds to transmission between B and F, for example corresponding to the use of five wavelengths (5λ), and
the third traffic demand corresponds to transmission between A and E, for example corresponding to the use of seven wavelengths (7λ).

Step No. 2 of the method determines the subpaths associated with the wavelengths 3λ, 5λ and 7λ that are liable to be grouped in the wavelength band WB1 to be allocated.

To this end, routing is effected by dividing the three traffic demands between certain links of the topology using a Dijkstra routing algorithm and a metric that is a function of the number of hops, i.e. of the number of links to be used to go from one node to another along a given itinerary.

This results in three explicit routes ABCDEF, BCDEF, ABCDE, for example, each subpath being a shorter path. In this example, passage via the node H is therefore excluded.

Alternatively, a routing algorithm may be chosen that calculates the first three shorter paths, whether they are connected or not. The choice may also be made to assign a weight to the links as a function of parameters other than the number of hops.

There are then fifteen subpaths of the routes ABCDEF, BCDEF, ABCDE identified by their entry and termination nodes, as follows: AB, AC, AD, AE, AF, BC, BD, BE, BF, CD, CE, CF, DE, DF, EF.

Then, as a function of the traffic demands, and for each of the fifteen subpaths, the volume of traffic to be supported from the beginning to the end of the subpath, i.e. the total number of wavelengths to be used end-to-end, is determined

The number of hops is also evaluated for each of the fifteen subpaths.

A cost function is then applied to each of the fifteen subpaths to evaluate their sensitivities, i.e. the respective likelihood of them being associated with the wavelength band WB1. In this example, the function corresponds to the product of the traffic volume (the total number of wavelengths) and a number one less than the number of hops.

If necessary, this product could be weighted by a factor representing an administrative cost and/or physical constraints, for example regenerator(s) to be added if the subpath is too long. The cost function must generally enable an improvement to be evaluated that it is intended to achieve if the higher granularity is used. It therefore corresponds to a difference between the cost of the means to be used to support the traffic with the lower granularity and the cost of the means to be used to support the traffic with the higher granularity.

Table 1 below shows the results of step No. 2.

TABLE 1

| Subpath | Traffic volume | Number of hop(s) | Cost function |
|---|---|---|---|
| AB | 3λ + 3λ | 1 | — |
| AC | 3λ + 7λ | 2 | 10 |
| AD | 3λ + 7λ | 3 | 20 |
| AE | 3λ + 7λ | 4 | 30 |
| AF | 3λ | 5 | 12 |
| BC | 3λ + 5λ + 7λ | 1 | — |
| BD | 3λ + 5λ + 7λ | 2 | 15 |
| BE | 3λ + 5λ + 7λ | 3 | 30 |
| BF | 3λ + 5λ | 4 | 24 |
| CD | 3λ + 5λ + 7λ | 1 | — |
| CE | 3λ + 5λ + 7λ | 2 | 15 |
| CF | 3λ + 5λ | 3 | 16 |
| DE | 3λ + 5λ + 7λ | 1 | — |
| DF | 3λ + 5λ | 2 | 8 |
| EF | 3λ + 5λ | 1 | — |

In step No. 3, the best subpath is elected based on the determination of the subpath having a maximum improvement given the chosen cost function.

In this example, the subpath BE is a better subpath because it transports the maximum traffic over the greatest possible distance. Also, the wavelength band WB1 actually capable of transporting fifteen wavelengths is allocated for the transport of data on the subpath BE.

If this band contained a maximum of only eight wavelengths, for example, then a second band of eight wavelengths would be used.

It may also be necessary to decide that the band WB1 should comprise only some of the wavelengths, the remaining wavelength(s) being switched individually.

In step No. 4, the traffic demands relating to the wavelengths are updated by eliminating traffic demands at the level of the best subpath BE and introducing traffic demands adjoining the best subpath BE, i.e. between A and B and between E and F.

Thus the new matrix indicates two residual traffic demands:
the first traffic demand corresponds to transmission between A and B corresponding to the use of ten wavelengths 3λ+7λ, and
the second traffic demand corresponds to transmission between E and F corresponding to the use of eight wavelengths 3λ+5λ.

The information on the allocation of the band WB1 is stored in a memory and the topology of the network 10 is modified by forming a new link between the entry node and the termination node of the best subpath BE. This logical link integrated into the topology of the network may be used during routing if the wavelength band WB1 is not filled and if traffic may pass over this link. Thus the subpath BE introduces a number of hops equal to 1.

In step No. 5, step No. 2 to step No. 4 are iterated until further allocation of the wavelength band provides no further improvement.

In this example, further allocation of the wavelength band or of a supplementary band is of no benefit since the route AB and the route EF comprise point-to-point links. Wavelength division multiplexing is still beneficial.

To rate the network 10, a minimum of one wavelength band switching matrix is provided in the nodes C and D, one wavelength switching matrix is provided in the nodes B and E, and a choice of a wavelength switching matrix or add and drop ports is provided in the node A.

The allocation method of this first embodiment may equally well be transposed to the dynamic reconfiguration of a network.

In the case of dynamic reconfiguration, the wavelength band switching matrices are activated in the nodes C and D, the wavelength switching matrices are activated in the nodes B and E, and the wavelength switching matrix or add and drop ports is/are activated in the node A.

The wavelength band WB1 may be allocated to the best subpath BE temporarily or permanently.

In a first variant (not shown), the network 10 may comprise another node X on the upstream side of the node A, i.e. on the side opposite the node B. Also, in this first variant, two new traffic demands between the nodes F and G and the nodes X and B may be detected dynamically, after the first iteration of the method, for example using distributed measuring means (not shown) in the network.

For example, information as to the necessity of these connections at the wavelength level is obtained by traffic measurements in distributed routers in the network. Also, this information is known from signaling in the control plane of the network.

The traffic demands firstly between the nodes X and B and between the nodes A and B, and secondly between the nodes E and F and between the nodes E and G, are independent in the sense that they may not form part of the same group. In this case, step No. 2 and step No. 3 may lead in the second iteration of the method to the election of two best subpaths and to the allocation of two wavelength bands.

The method of the invention may also be applied if the lower resources are packets and the higher resources are circuits or wavelengths, for example.

The method of the invention also proposes that the distribution of the traffic demands in time and in space should be determined by software or hardware, either by distributed means in the network and on the basis of information from a routing protocol dedicated to the lower resources, or by external and centralized management means.

The method of the invention also proposes using a plurality of traffic matrices, for example static traffic matrices, to impart a statistical dimension. For example, account is taken of traffic demands varying at different times of day. In this case, the choice of the best subpath will be decided relative to an optimum at the day level and that does not necessarily represent the optimum for each time of day.

Requirements at different times are taken into account in producing the cost function. For example, if there is a requirement for three wavelengths in the morning and ten wavelengths in the evening, ten wavelengths are chosen.

The invention also proposes intelligent routing that integrates predictively the improvement of the cost function. For example, instead of choosing a metric equal to 1, as with a Dijkstra algorithm, the links are assigned a varying metric that is inversely proportional to the link traffic. In this way the traffic is aggregated as much as possible.

1. A method of allocating a resource (WB1) in a telecommunications network (10) having a multigranular architecture and a given topology defining, for each level of granularity, nodes and links between adjacent nodes, the network (10) comprising a first resource (WB1) called the higher resource having a higher level of granularity than second resources called lower resources, which method is characterized in that it comprises the following steps:
a step No. 1 of determining traffic demands between source nodes and destination nodes and relating to said lower resources,
a step No. 2 comprising:
routing, i.e. distributing traffic demands over at least some of the links, the routing process defining routes (ABCDEF, BCDEF, ABCDE),
counting subpaths relating to said routes, a subpath being identified by an entry node and a termination node situated on one of said routes,
determining the traffic volume on each of said subpaths as a function of said traffic demands, and
applying a cost function on each of said subpaths, the cost function being used to evaluate an improvement,
a step No. 3 comprising:
electing from said subpaths a best subpath (BE) for which the improvement evaluated by the cost function is a maximum, and
allocating at least said higher resource to said best subpath (BE) for handling at least some of the lower resources and the corresponding traffic,
a step No. 4 of updating the traffic demands relating to the lower resources, comprising:
eliminating the traffic demands at the origin of traffic initially intended to take this best subpath by means of said portion of the lower resources, but handled by said higher resource,
introducing traffic demand(s) adjacent said best subpath in each situation where a traffic demand handled by said higher resource: 1/ has a node on the upstream side of said entry node for its source node and does not involve crossing said termination node, or: 2/ has for its destination node a node situated on the downstream side of said termination node and does not involve crossing said entry node, or: 3/ has for its source node and its destination node respective nodes upstream of said entry node and downstream of said termination node, the adjacent traffic demands introduced being respectively, in situation 1/, the traffic demand with said entry node for the new destination node, in situation 2/, the traffic demand with said termination node for the new source node, and in situation 3/, the traffic demand with said entry node for the new destination node and the traffic demand with said termination node for the new source node, and a step No. 5 of reiterating steps No. 2 to No. 4 until any allocation of a higher resource provides no further improvement.

2. A method according to claim I of allocating a resource, characterized in that step No. 1 is executed using a choice between:
at least one static traffic matrix, and
at least one stochastic traffic matrix.

3. A method according to claim 1 of allocating a resource (WB1), characterized in that the routing is effected using a Dijkstra routing algorithm.

4. A method according to claim 1 of allocating a resource (WB1), characterized in that the routing integrates predictively a maximum improvement.

5. A method according to claim 1 of allocating a resource (WB1), characterized in that said cost function takes account of one or more of the following parameters: the lengths of the subpaths, physical constraints, and an administrative cost.

6. A method according to claim 1 of allocating a resource, characterized in that, if said lower resources are packets, said cost function takes account of an equivalent bandwidth estimate.

7. A method according to claim 1 of allocating a resource (WB1), characterized in that the step No. 4 comprises the formation of a new link in the topology between the entry node and the termination node of said best subpath (BE).

8. A method according to claim 1 of allocating a resource, characterized in that the step No. 4 comprises the management of a memory associated with the allocated higher resources, said memory containing one or more of the following: the number of hops for each best subpath, the length of each best subpath, the entry and termination nodes of each best subpath.

9. A method according to claim 1 of allocating a resource, characterized in that, if the steps No. 2 and No. 3 lead, in the same iteration, to the election of at least two different best subpaths, at least two higher resources are allocated.
